(19) United States
(12) Patent Application Publication
(10) Pub. No.: US 2023/0398960 A1
(43) Pub. Date: Dec. 14, 2023

(54) METHODS AND SYSTEMS FOR THEFT DETERRENT OF VEHICLES

(71) Applicant: Toyota Motor North America, Inc., Plano, TX (US)

(72) Inventors: Roger Akira Kyle, Aubrey, TX (US); Timothy Wang, Ann Arbor, MI (US); Bryan Else Yamasaki, Frisco, TX (US); Justin K. Shen, Canton, MI (US); Prince Ramos Remegio, McKinney, TX (US)

(73) Assignees: Toyota Motor North America, Inc., Plano, TX (US); Toyota Jidosha Kabushiki Kaisha, Achi-ken (JP)

(21) Appl. No.: 17/836,205

(22) Filed: Jun. 9, 2022

(51) Int. Cl. B60R 25/30; B60R 25/10

(52) U.S. Cl. CPC B60R 25/30; B60R 25/1004

(57) ABSTRACT

A method is provided. The method includes determining a vehicle is stolen, displaying on a display an image indicating the vehicle is stolen upon determining the vehicle is stolen. The image provides identification information of the vehicle. The method further includes executing a theft prevention measure including rendering the vehicle not drivable upon determining the vehicle is stolen.

### TECHNICAL FIELD

The present specification generally relates to methods and systems for deterring vehicle theft utilizing a display.

### BACKGROUND

Vehicles are often subject to theft or vandalism and may require a system deterring vehicle theft. Specifically, the system may utilize a display to communicate the stolen status of the vehicle.

### SUMMARY

In one embodiment, a method is provided. The method includes determining a vehicle is stolen, displaying on a display an image indicating the vehicle is stolen upon determining the vehicle is stolen. The image provides identification information of the vehicle. The method further includes executing a theft prevention measure including rendering the vehicle not drivable upon determining the vehicle is stolen.

In another embodiment, a theft deterrent system is provided. The theft deterrent system includes a controller communicatively coupled a vehicle. The vehicle includes a display configured to display an image indicating the vehicle is stolen. The image includes an identification information of the vehicle. The controller determines the vehicle is stolen, causes the display to display the image upon determining the vehicle is stolen, and executes a theft prevention measure including rendering the vehicle not drivable.

In yet another embodiment, a non-transitory computer readable medium is provided. The non-transitory computer readable medium includes an instruction. The instruction, when executed by a processor, causes the processor to perform determining a vehicle is stolen, and displaying on a display an image indicating the vehicle is stolen upon determining the vehicle is stolen. The image provides identification information of the vehicle. The instruction further causes the processor to perform executing a theft prevention measure including rendering the vehicle not drivable upon determining the vehicle is stolen.

These and additional objects and advantages provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of an illustrative system for deterring theft of a vehicle, according to one or more embodiments shown or described herein;

FIG. 2 schematically depicts the illustrative system of FIG. 1, according to one or more embodiment shown or described herein;

FIG. 3 schematically depicts a method for deterring theft of a vehicle, according to one or more embodiments shown or described herein.

### DETAILED DESCRIPTION

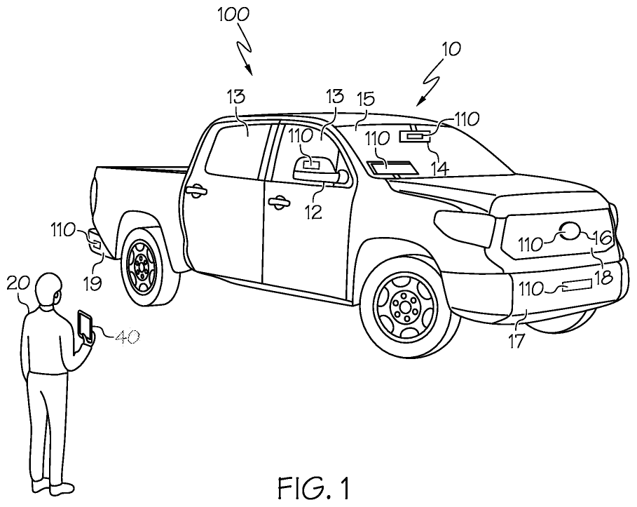

The present disclosure generally relates to methods and systems deterring theft of a vehicle. The method may determine a vehicle is stolen and display an image indicating the vehicle is stolen on a display to communicate the stolen status of the vehicle. The image may provide identification information of the owner of the vehicle or the vehicle itself. The method may further execute a theft prevention measure, for example, rendering the vehicle not drivable. Referring now to FIG. 1, a system 100 for deterring theft of a vehicle 10 is depicted. The vehicle 10 include one or more displays 110 that are visible from the outside of the vehicle 10. The display 110 is configured to display an image indicating that the vehicle is stolen. For non-limiting example, the display 110 may be disposed on a side mirror of the vehicle 10. The side mirror itself may constitute the display 110 or the display 110 may be disposed on a backside of the side mirror. The display 110 may be disposed on the back side of a rear view mirror. An emblem of the vehicle 10 may constitute the display 110. For example, the emblem may display a logo of the brand and display the image when the vehicle 10 is stolen. Front and back bumpers of the vehicle 10 may have the display 110. The display 110 may be disposed inside or outside of the vehicle 10 as long as visible from outside of the vehicle 10. The display 110 may be one of the components of the vehicle 10 or a standalone component. For non-limiting example, the display 110 may be a cathode ray tube, light emitting diodes, a liquid crystal display, a plasma display, or the like.

In embodiments, the image displayed on the display 110 may be a picture, a video, and/or a description indicative of the vehicle 10 is stolen. For example, the image may have a distinctive color, font, and/or special effect including blinking that may draw attention of a user 20. The image may provide various information related to the vehicle 10. For non-limiting example, the image may provide identification information of the vehicle 10 (e.g., VIN number, registration number, or the like), an owner of the vehicle 10 (e.g., name, entity, or the like), contact information of the owner (e.g., phone number, email address, or the like), contact information of a customer center (e.g., phone number, email address, or the like), and/or contact information of law enforcement officials (e.g., 911, local emergency number, local police number, or the like).

In embodiments, the image may provide the various information directly or indirectly by stating statements related to the information in the image or providing access to the information. For example, the image may provide a link, a quick response (QR) code, or a barcode that may be accessible or readable by a user device 310 (e.g., a user interface), such as a smart phone, a tablet, or a computer. The user 20 may notice the image indicating the vehicle 10 is stolen, and the information is provided to the user 20 through the display 110 or the user device 310. The user 20 may contact the contact information provided by the image. For example, the user 20 may use the user device 310 to read the code or the link associated with the image using a camera coupled to the user device 310, tap on a dial number or an email address provided on a display coupled to the user device 310, manually access the code or the link by input the address using a user interface coupled to the user device 310, or manually call the dial number provided in the image.

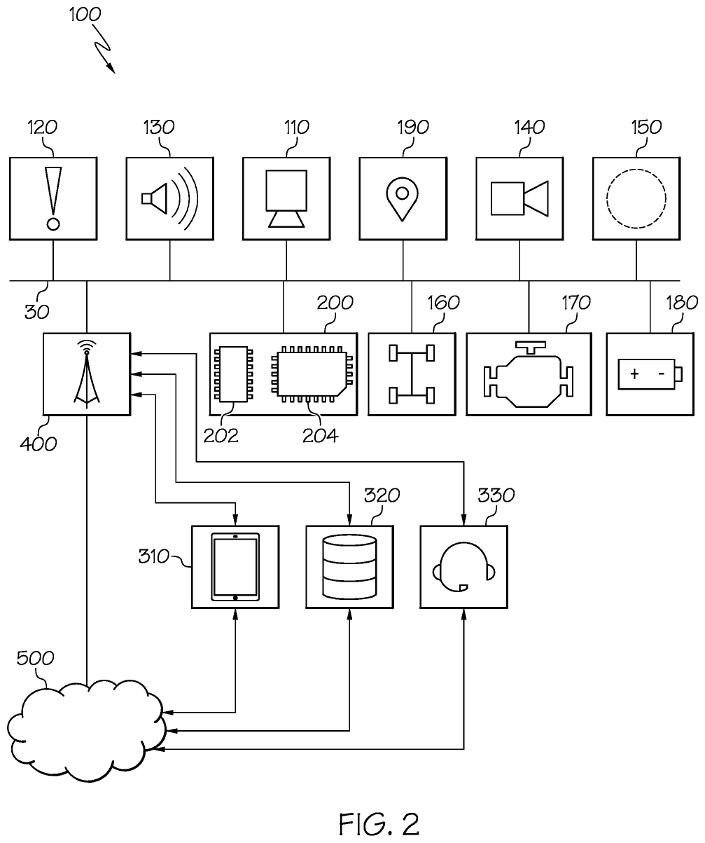

Referring to FIG. 2, the system 100 includes a controller 200 including a processor 202 and a memory module 204. The controller 200 may be an electronic control unit in some embodiments. The system 100 may include the display 110, an alarm module 120, an audio module 130, one or more sensors including an image sensor 140 and a contact sensor 150, various driving components and a network interface 400. The driving components may include any components of the vehicle 10 that may make the vehicle 10 drivable including, as non-limiting example, a drivetrain 160, an engine 170, a power source 180, or the like. In some embodiments, the network interface 400 may communicatively couple the system 100 with an external network 500 (e.g., a cloud network), the user device 310, a database 320, an operating system provider 330, or the like. The various components of the system 100 may be communicatively coupled to one another via a bus 30.

In embodiments, the processor 202 includes any processing component(s) configured to receive and execute instructions. The instructions may be in the form of one or more processor-readable instructions or instruction sets stored in the memory module 204. Accordingly, the processor 202 may be an electric controller, an integrated circuit, a microchip, a computer, or any other computing device. The processor 202 may be communicatively coupled to the other components of the system 100 via the bus 30. Accordingly, the bus 30 may communicatively couple any number of processors 202 with one another, and allow the components coupled to the bus 30 to operate in a distributed computing environment. Each of the components may operate as a node that may send and/or receive data. Furthermore, while the embodiment depicted in FIG. 2 includes a single processor 202, some embodiments may include more than one processor 202 without departing from the scope of the present disclosure.

As noted above, the controller 200 includes the memory module 204. The memory module 204 is communicatively coupled to the one or more processors 202. The memory module 204 may include RAM, ROM, flash memories, hard drives, or any device capable of storing processor-readable instructions such that the processor-readable instructions may be accessed and executed by the one or more processors 202. The processor-readable instructions may include logic or algorithm(s) written in any programming language of any generation (e.g., 1GL, 2GL, 3GL, 4GL, or 5GL) such as, for example, machine language that may be directly executed by the processor 202, or assembly language, object-oriented programming (OOP), scripting languages, microcode, and the like, that may be compiled or assembled into processor-readable instructions and stored on the memory module 204. In some embodiments, the processor-readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 2, the bus 30 is formed from any medium that is capable of transmitting a signal such as, for example, conductive wires, conductive traces, optical waveguides, or the like. Moreover, the bus 30 may be formed from a combination of mediums capable of transmitting signals. In embodiments, the bus 30 may include a combination of conductive traces, conductive wires, connectors, and buses that cooperate to permit the transmission of electrical data signals to components such as processors, memories, sensors, input devices, output devices, and communication devices. Accordingly, the bus 30 may include a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The bus 30 may communicatively couple the various components of the system 100. As used herein, the term “communicatively coupled” means that coupled components are capable of exchanging data signals with one another such as, for example, electrical signals via conductive medium, electromagnetic signals via air, optical signals via optical waveguides, and the like.

The alarm module 120 includes any hardware device capable of generating a visual alert to gather the attention of the user 20. In embodiments, the alarm module 120 may include one or more lights configured to emit light outside of the vehicle 10. In embodiments, the alarm module 120 may include the headlights, taillights, brake lights, and the like of the vehicle 10 capable of being perceived from outside the vehicle 10. The memory module 204 may include alarm instructions executable by the processor 202. Upon executing the alarm instructions, the processor 202 may instruct one or more components of the alarm module 120, such as lights or the like, to activate in any desirable pattern.

The audio module 130 includes any hardware device capable of generating an audio alert or noises audible outside of the vehicle 10 to gather the attention of the user 20. The audio module 130 may include a car horn, a siren, or an audio system of the vehicle 10. The audio module 130 may be built-in systems of the vehicle 10 that are operational outside of the system 100. For instance, the audio module 130 may a speaker system of the vehicle 10. The memory module 204 may include audio instructions executable by the processor 202. Upon executing the audio instructions, the processor 202 may instruct one or more components of the audio module 130 to provide noise or sound to the user 20.

The various sensors including the image sensor 140 and the contact sensor 150 are configured to detect removal of the various components of the vehicle 10. The sensors may detect removal of the components of the vehicle 10 such as headlights, taillights, the displays 110, tires, the driving components including the drivetrain 160 and the engine 170, the power source 180, navigation modules, or any components that are coupled to the vehicle 10 of which the removal may indicate that the vehicle 10 is stolen. In embodiments, the image sensor 140 may detect removal of the components by processing image taken by the image sensor 140. The image taken by the image sensor 140 may indicate absence or presence of the components. For example, the image sensor 140 may be a camera, a depth map sensor, an optical sensor, or the like. In embodiments, the contact sensor 150 may detect removal of the components by sensing non-contact or contact of the components. For example, the contact sensor 150 may include a capacitive or resistive sensor, a pressure sensor, a mechanical switch, or the like. The sensors may further include a proximity sensor that may detect whether the components are within or outside of a threshold distance range. For non-limiting example, the proximity sensor may be a RFID sensor, a GPS device, or any device able to define or detect distances around the vehicle 10.

In embodiments, the various sensors may generate sensor data. The sensor data may encompass still image data, video data, radar data, ultrasonic data, LiDAR data, and/or the like depending the sensor utilized in the system 100. The memory module 204 may include sensor instructions executable by the processor 202. Upon executing the sensor instructions, the processor 202 may instruct the sensors to detect the removal of the components of the vehicle 10. Moreover, upon executing the sensor instructions, the processor 202 may analyze the sensor data received from the sensors.

The system 100 may be coupled to the power source 180. The power source 180 may be a battery coupled to the driving component of the vehicle 10. In embodiments, the power source 180 may be a 12-volt lead-acid battery. In embodiments, the power source 180 may be a hybrid battery, such as lithium-ion battery or a nickel-metal hydride battery. In embodiments, the system 100 may be coupled to multiple power sources 180, such as a 12-volt lead-acid battery and a hybrid battery. In some embodiments, the power source may be a separate battery for operation of the system 100 that is not coupled to the vehicle 10. The system 100 may draw power from the power source while the system 100 is operating.

The power source 180 may further be coupled to the components of the vehicle 10, such as the display 110, the alarm module 120, the audio module 130, the various sensors including the image sensor 140 and the contact sensor 150, the various driving components including the drivetrain 160 and the engine 170, and the network interface 400 to supply power to operate the components. Disconnection of the power source 180 from the system 100 may render the vehicle 10 not drivable. For example, the disconnection of the power source 180 may render the driving components of the vehicle 10 including drivetrain 160 and the engine 170 not operable. In embodiments where the vehicle 10 is powered by non-electrical fuel (e.g., gasoline, diesel, or the like), the power source 180 may be a fuel tank. Therefore, disconnection of the power source 180 may include disconnecting fuel lines from the fuel tank, stop supplying fuel from the fuel tank, or the like. In embodiments where the vehicle 10 is powered by electrical fuel (e.g., electric vehicles, hybrid vehicles, or the like), the power source may be a battery. Therefore, disconnection of the power source 180 may include disconnecting electrical wires from the battery, stop supplying electricity from the battery, or the like.

The network interface 400 may be communicatively coupled to the controller 200 via the bus 30. The network interface 400 may be any device capable of transmitting and/or receiving data with external devices or servers directly or via a network, such as an external network 500. Accordingly, the network interface 400 can include a communication transceiver for sending and/or receiving any wired or wireless communication. For example, the network interface 400 may include an antenna, a modem, LAN port, Wi-Fi card, WiMax card, mobile communications hardware, near-field communication hardware, satellite communication hardware and/or any wired or wireless hardware for communicating with other networks and/or devices. In embodiments, the network interface 400 may include hardware configured to operate in accordance with the Bluetooth wireless communication protocol and may include a Bluetooth send/receive module for sending and receiving Bluetooth communications.

In some embodiments, the system 100 may be communicatively coupled to a network such as the external network 500. In embodiments, the external network 500 may include one or more computer networks (e.g., a cloud network, a personal area network, a local area network, grid computing network, wide area network, and the like), cellular networks, satellite networks, mesh networks, and/or a global positioning system and combinations thereof. Accordingly, the system 100 can be communicatively coupled to the external network 500 via wires, via a wide area network, via a local area network, via a personal area network, via a cellular network, via a satellite network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

In some embodiments, the network interface 400 may communicatively couple the system 100 with the user device 310. The user device 310 may be a personal electronic device of the user 20. The user device 310 may generally be used as an interface between the user 20 and the other components connected to the network interface 400. Thus, the user device 310 may be used to perform one or more user-facing functions, such as receiving one or more inputs from the user 20 or providing information to the user 20. Accordingly, the user device 310 may include at least a display and/or input hardware.

In embodiments, the user device 310 may be communicatively paired with the system 100 such that the user device 310 transmits GPS or other location data to the controller 200. In embodiments, the user 20 may instruct operation of the alarm module 120, the audio module 130, and/or other system 100 components through the user device 310. The user device 310 may be a cellular phone, tablet, or personal computer. The user device 310 may include a display such as, for example, a cathode ray tube, light emitting diodes, a liquid crystal display, a plasma display, or the like. Moreover, the display may be a touchscreen that, in addition to providing an optical display, detects the presence and location of a tactile input upon a surface of or adjacent to the display.

It should be appreciated that the display of the user device 310 is merely an example that the user 20 may receive or provide operations instructions to the system 100 from. In embodiments, the system 100 may provide the image similar to the image displayed on the display 110 of the vehicle 10. The user device 310 may display the image that may provide the various information by stating in the image or providing access to the information. For example, the image may provide a link, a quick response (QR) code, or a barcode that may be accessible by the user device 310. In embodiments, the image may indicate the vehicle 10 is stolen.

The various information related to the vehicle 10 may be provided to the user 20 through the user device 310. For non-limiting example, the image may provide identification information of the vehicle 10 (e.g., VIN number, registration number, or the like), an owner of the vehicle 10 (e.g., name, entity, or the like), contact information of the owner (e.g., phone number, email address, or the like), contact information of a customer center (e.g., phone number, email address, or the like), and/or contact information of law enforcement officials (e.g., 911, local emergency number, local police number, or the like).

The user 20 may contact the contact information provided by the image. For example, the user 20 may use the user device 310 tap on a code, a link, or a dial number provided by the image, manually access to the code, or manually call the dial number. The user 20 may scan the link or the code that may automatically send notification indicative of the vehicle 10 is stolen.

In some embodiments, the network interface 400 may communicatively couple the system 100 with the database 320 that may store the various information related to the vehicle 10. The database 320 may be any database server or electronic device belonging to the user 20, the owner of the vehicle 10, the law enforcement entity, the customer center, or any third party. The database 320 may be configured to provide services to other programs or devices through a server coupled to the database 320. For instance, the database 320 may contain one or more storage devices for storing data pertaining to the operation of the system 100. The database 320 may store data pertaining to the location of the vehicle 10, the sensor data collected the sensors 140, 150, data pertaining to the components of the vehicle 10 that cause the processor 202 to initiate a responsive action via the alarm module 120 and the audio module 130, for instance, and the like.

The system 100 may share data including the data stored in the database 320 with the operating system provider 330. The operating system provider 330 may be a server providing further service utilizing the database 320. The operating system provider 330 may be configured to communicate with, as non-limiting example, a government-operated body such as a police force, a fire department, or the like. In embodiments, an operating system provider 330 may be configured to communicate with independent emergency response organizations (e.g., customer service center, security service provider, or the like) that may then coordinate with one or more government-operated bodies. In some embodiments, the database 320 may provide data to an emergency contact selected by the owner of the vehicle 10 or the operating system provider 330. For instance, the owner or the operating system provider 330 may designate a family member, friend, or any other person or organization as an emergency contact. When the controller 200 determines that the vehicle 10 is stolen, the controller 200 may push an alert notification to the one or more user devices 310. The user device 310 may belong to the user 20 or the owner of the vehicle 10 or individuals or organizations designated by the owner of the vehicle 10 or the operating system provider 330. The notification pushed to the one or more user devices 310 may further include location data relating to the current location of the vehicle 10.

In embodiments, the system 100 may include a navigation module. The navigation module may store common travel patterns of the vehicle 10 and further determine a current position of the vehicle 10. The navigation module may be able to obtain and update positional information based on geographical coordinates (e.g., latitudes and longitudes), or via electronic navigation where the navigation module electronically receives positional information through satellites. In some embodiments, the navigation module may include a GPS system. The navigation module may provide navigation data may include common travel patterns of the vehicle 10 based on its own determination, common travel patterns of the vehicle 10 based on user-input information such as a home address, a work address, and the like. The controller 200 may receive navigation data, including common travel pattern data and current vehicle 10 position data, from the navigation module. The controller 200 may determine whether the vehicle 10 is stolen based on the navigation data. For example, the controller 200 may determine whether the vehicle 10 is within the common travel pattern.

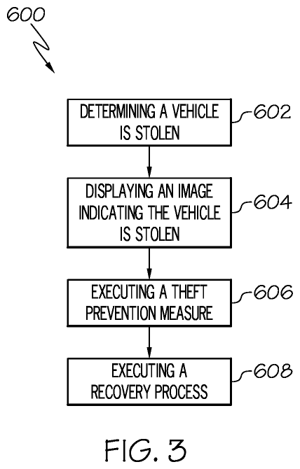

FIG. 3 schematically depicts a method 600 for deterring theft of the vehicle 10. The method 600 may be executed based on an instruction from an internal or external source. In embodiments, the method 600 may be executed based on an instruction stored in the memory module 104 that are executed by the processor 202. In embodiments, the method 600 may be executed based on an instruction from the user device 310, the database 320, the operating system provider 330, or the like.

Referring to FIG. 3, at block 602 of the method 600, the system 100 may determine whether the vehicle 10 is stolen. The determination may made based on removal of the components of the vehicle 10, notification indicating the vehicle 10 is stolen received by the system 100, or any presence of activities indicating the vehicle 10 is stolen. In embodiments, the determination may be based on the removal of the components of the vehicle 10. For example, removal of the components of the vehicle 10 such as headlights, taillights, the displays 110, navigation modules, the driving components including tires, the drivetrain 160, the engine 170, the power sources 180, or any components that are coupled to the vehicle 10 may indicate that the vehicle 10 is stolen.

In embodiments, replacing the component of the vehicle 10 still may indicate the vehicle 10 is stolen. For example, once the component is removed from the vehicle 10, the controller 200 may determine the vehicle 10 is stolen even when the component is returned back in the vehicle 10 or being replaced in place of the removed component. For example, when the removed display 110 is replaced, the controller 200 may display the image indicating the vehicle is stolen on the replaced display.

In embodiments, determining the vehicle is stolen may be based on the notification indicating the vehicle 10 is stolen. The notification may be from the user device 310, the operating system provider 330, the database 320, or any devices or systems communicatively coupled to the system 100. For example, the owner of the vehicle 10 or the user 20 may notify the system 100 directly or indirectly through, for example, the operating system provider 330, the user device 310, or the like to trigger the system 100 to provide theft prevention measures.

In embodiments, determining the vehicle is stolen may be based on the data provided by the system 100. The data may be the sensor data from the one or more sensors including the image sensor 140 and the contact sensor may be indicative of removal of the components of the vehicle 10, presence of unidentified personnel near the vehicle 10, unauthorized attempt to open the doors or the hood of the vehicle 10, or the like. The data may be the navigation data indicating the position of the vehicle 10, the travel pattern of the vehicle 10, or the like. For example, the navigation data may indicate that the vehicle 10 is removed from the parking space, or the vehicle 10 deviates from the common travel pattern.

At block 604, the system 100 may display the image indicating the vehicle 10 is stolen upon determining the vehicle 10 is stolen. The image may be displayed on the display 110, the display of the user device 310, or any display coupled to the system 100. In case where the vehicle 10 has multiple displays 110, removal of one of the display 110 may trigger the system 100 to display the image on another display 110. In case where the vehicle 10 has one display 110, removal of the display 110 may trigger the system 100 to display the image on other display, such as the display of the user device 310 or any display coupled to the system 100.

In embodiments, the image may provide identification information of the vehicle directly or indirectly. For example, the image may provide vehicle information (e.g., VIN number, registration number, or the like), an owner of the vehicle 10 (e.g., name, entity, or the like), contact information of the owner (e.g., phone number, email address, or the like), contact information of a customer center (e.g., phone number, email address, or the like), and/or contact information of law enforcement officials (e.g., 911, local emergency number, local police number, or the like). The image may provide an access to the identification information that may be accessed by the user 20 as discussed herein above.

In embodiments, the block 604 may further include activating the alarm module 120 that may provide visual alert and/or the audio module 130 that may provide audio alert. The alert may draw attention from people (e.g., the user 20) present near the vehicle 10.

At block 608, the system 100 may execute the theft prevention measure upon determining the vehicle 10 is stolen. The theft prevention measure any measure that may prevent or deter theft of the vehicle 10. For non-limiting example, the theft prevention measure may include rendering the vehicle 10 not drivable, externally communicating information indicating the vehicle 10 is stolen, activating and/or externally communicating a flag indicating the vehicle is stolen, or the like.

In embodiments, rendering the vehicle 10 not drivable may include severing the connection between the driving components such as the drivetrain 160, the engine 170, a fuel pump, and a vehicle ignition of the vehicle 10 from the power source 180. For example, the controller 200 may block fuel supply to the engine 170, turn off the fuel pump, turn off the vehicle ignition, or the like. The controller 200 may restrict physical movement of the vehicle 10. For example, the controller 200 may uncouple the drivetrain 160 from the wheels, activate a braking system of the vehicle 10, or the like.

In embodiments, the controller 200 may externally communicate information indicating the vehicle 10 is stolen to execute the theft prevention measure to take place. For example, the controller 200 may communicate to the user device 310, the database 320, or the operating system provider 330 the information indicating the vehicle 10 is stolen to receive an instruction to execute the theft prevention measure. In embodiment, the controller 200 may execute the theft prevention measure without the instruction, but automatically execute the theft prevention measure upon determining the vehicle 10 is stolen.

In embodiments, the controller 200 may externally communicate information indicating the vehicle 10 is stolen in the form of a flag. The flag may be set in a “true” state when the vehicle 10 is stolen, and the flag may be set in a “false” state when the vehicle 10 is not stolen. The flag in the “true” state may be activated to be sent to the user device 310, the database 320, or the operating system provider 330 upon determining the vehicle 10 is stolen.

At block 608, the system 100 may execute a recovery process. The recovery process may be executed upon the determination of the vehicle 10 is stolen, the display of the image, or the execution of the theft prevention measure. The system 100 may notify personnel or organization to recover the stolen vehicle 10. For non-limiting example, the system 100 may notify law enforcement officials, insurance providers or leasing companies associated with the vehicle 10, security companies, or the like. The notification may sent by any components or systems coupled to the system 100 (e.g., the controller 200, the user device 310, the database 320, the operating system provider 330, or the like). The system 100 may provide the identification information of the vehicle 10, data obtained from the vehicle 10 (e.g., sensor data, navigation data, time data, or the like obtained from the vehicle 10), data obtained from the user device 310 (e.g., location data, identification data, time data, or the like obtained from the user device 310), data stored in the database 320, and/or data provided by the operating system provider 330. The recovery process may eventually locate the stolen vehicle 10 and support returning of the vehicle 10 to the owner.

In embodiments, the vehicle 10 may be made drivable upon completion of the recovery process. The completion of the recovery process may include regaining possession or control of the vehicle 10 by the owner, the law enforcement officials, the insurance company, the security company, anyone authorized to recover the vehicle 10, or the like. The vehicle 10 may become drivable when the system 100 receives or determines the recovery process is completed. The system 100 may recover the severed connection between the driving components such as the drivetrain 160, the engine 170, a fuel pump, and a vehicle ignition of the vehicle 10 and the power source 180. For example, the controller 200 may unblock fuel supply to the engine 170, turn on the fuel pump, turn on the vehicle ignition, or the like. The controller 200 may lift the movement restriction of the vehicle 10. For example, the controller 200 may couple the drivetrain 160 and the wheels, deactivate the braking system of the vehicle 10, or the like. In embodiments, the system 100 may set the flag in the “false” state after completing the recovery process.

Based on the foregoing, it should now be understood that embodiments shown and described herein relate to methods, systems, and non-transitory computer readable media for deterring theft of a vehicle by utilizing a display and rendering the vehicle not drivable in case the vehicle is determined to be stolen. The methods, systems, and non-transitory computer readable media may continue to display an image indicative of the vehicle is stolen or continue to keep the vehicle not drivable until it is determined that the vehicle is not stolen, or a recovery process is completed.

The systems, methods, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method, comprising:
determining a vehicle is stolen;
displaying on a display an image indicating the vehicle is stolen upon determining the vehicle is stolen, the image providing identification information of the vehicle; and
executing a theft prevention measure including rendering the vehicle not drivable upon determining the vehicle is stolen.

2. The method of claim 1, wherein the theft prevention measure further includes severing a connection between a driving component of the vehicle and a power source of the driving component to render the vehicle not drivable.

3. The method of claim 1, wherein the theft prevention measure further includes externally communicating information indicating the vehicle is stolen.

4. The method of claim 1, wherein the theft prevention measure further includes activating a flag indicating the vehicle is stolen.

5. The method of claim 1, further comprising executing a recovery process upon determining the vehicle is stolen.

6. The method of claim 5, further comprising making the vehicle drivable upon completing the recovery process.

7. The method of claim 1, wherein the determination of the vehicle is stolen is made upon determining a component of the vehicle is removed.

8. The method of claim 7, wherein the component is another display configured to display the image indicating the vehicle is stolen.

9. The method of claim 1, wherein the image provides a link triggering a recovery process upon access.

10. The method of claim 1, wherein the identification information is associated with an owner of the vehicle.

11. A theft deterrent system, comprising:
a controller communicatively coupled a vehicle, the vehicle including a display configured to display an image indicating the vehicle is stolen, the image including an identification information of the vehicle,
wherein the controller:
determines the vehicle is stolen,
causes the display to display the image upon determining the vehicle is stolen, and
executes a theft prevention measure including rendering the vehicle not drivable.

12. The theft deterrent system of claim 11, wherein the theft prevention measure further includes severing a connection between a driving component of the vehicle and a power source of the driving component to render the vehicle not drivable.

13. The theft deterrent system of claim 11, wherein the theft prevention measure further includes externally communicating information indicating of the vehicle is stolen.

14. The theft deterrent system of claim 11, wherein the theft prevention measure further includes activating a flag indicating the vehicle is stolen.

15. The theft deterrent system of claim 11, wherein the controller further executes a recovery process upon determining the vehicle is stolen.

16. The theft deterrent system of claim 15, wherein the controller further makes the vehicle drivable upon completing the recovery process.

17. The theft deterrent system of claim 11, wherein the determination of the vehicle is stolen is made upon determining a component of the vehicle is removed.

18. A non-transitory computer readable medium comprising an instruction that, when executed by a processor, causes the processor to perform:
determining a vehicle is stolen;
displaying on a display an image indicating the vehicle is stolen upon determining the vehicle is stolen, the image providing identification information of the vehicle; and
executing a theft prevention measure including rendering the vehicle not drivable upon determining the vehicle is stolen.

19. The non-transitory computer readable medium of claim 18, wherein the instruction further causes the processor to perform:
severing a connection between a driving component of the vehicle and a power source of the driving component to render the vehicle not drivable.

20. The non-transitory computer readable medium of claim 18, wherein the instruction further causes the processor to perform:
externally communicating an information related to the determination that the vehicle is stolen.
